(19) United States
(12) Patent Application Publication
(10) Pub. No.: US 2019/0264854 A1
(43) Pub. Date: Aug. 29, 2019

(54) Throttling Explosion-Proof Pipe Assembly

(71) Applicants: Pao-Tang Chen, Lukang Township (TW); Hung-Shan Chen, Lukang Township (TW)

(72) Inventor: Chi-Fu Chen, Lukang Township (TW)

(21) Appl. No.: 15/905,920

(22) Filed: Feb. 27, 2018

(51) Int. Cl. F16L 55/05

(52) U.S. Cl. CPC F16L 55/05

(57) ABSTRACT

A throttling explosion-proof pipe assembly includes a main body, a control member, a cover and an explosion-proof pipe. The explosion-proof pipe is provided with a coupling which has an interior provided with a mounting hole which has an inner diameter equal to an outer diameter of the main body. A nut is rotatably mounted on the explosion-proof pipe through 360 degrees. The nut is provided with an internal thread. The main body, the control member and the cover are integrated to construct a throttling valve that is received in the mounting hole of the explosion-proof pipe.

### BACKGROUND OF THE INVENTION

### 1. Field of the Invention

The present invention relates to a pipe and, more particularly, to a throttling explosion-proof pipe assembly.

### 2. Description of the Related Art

An explosion-proof pipe is used to convey a high pressure fluid, such as gas, oil or the like, so that the explosion-proof pipe is disposed at the state with a determined pressure. When the pressure applied on the explosion-proof pipe is large to exceed the predetermined value, the explosion-proof pipe is broken easily, thereby causing danger to the user. Thus, it is necessary to provide a control device to control the flow rate in the explosion-proof pipe and to shut the flow in the explosion-proof pipe when the pressure applied on the explosion-proof pipe exceeds the predetermined value. However, the conventional explosion-proof pipe is not provided with such a control device, thereby causing danger to the user.

A conventional flow control valve shown in FIGS. 1 and 2 comprises a valve body 10, a control member 20 and a cover 30. The valve body 10 has an interior provided with a receiving space. The receiving space of the valve body 10 is provided with a resting face 14 and a shaft portion 15. The shaft portion 15 is provided with a stepped face 16, and a positioning groove 17 is defined between the stepped face 16 and the resting face 14. The positioning groove 17 of the valve body 10 is provided with a plurality of water outlet holes 18. The control member 20 has a bushing 21 mounted on the shaft portion 15. The control member 20 is provided with an elastic portion 23. The control member 20 is provided with a positioning projection 24. The cover 30 has a flange 31 mounted on the bushing 21. The cover 30 has a plurality of water inlet holes 32 connected to the receiving space of the valve body 10. In assembly, a water pipe 40 is provided with a coupling 41 which is connected with a fitting 42. The coupling 41 has an internal thread 411 screwed onto an external thread 421 of the fitting 42. The flow control valve is mounted in the fitting 42. A water inlet pipe 1 is mounted in a wall. A three-way connector 50 is mounted between the water inlet pipe 1 and the fitting 42. The three-way connector 50 includes a first pipe 51 locked into the water inlet pipe 1, a second pipe 52 locked into the fitting 42 and a third pipe 53 provided with a switch 54. The fitting 42 has an internal thread 422 screwed onto the second pipe 52 of the three-way connector 50. The switch 54 is movable between a first position where the first pipe 51 is connected to the second pipe 52 so that the water in the water inlet pipe 1 flows through the first pipe 51 and the second pipe 52 into the water pipe 40, and a second position where the first pipe 51 is disconnected from the second pipe 52 so that the water in the water inlet pipe 1 is interrupted. When the flow pressure of the fluid is under the normal condition, the fluid flows through the first pipe 51 into the second pipe 52, then evenly flows from the water inlet holes 32 of the cover 30 into the valve body 10, and then flows through the water outlet holes 18 of the valve body 10 into the water pipe 40. When the flow pressure of the fluid is under the abnormal condition, the elastic portion 23 of the control member 20 is expanded outward and abuts the stepped face 16 of the valve body 10, so that the control member 20 abuts the resting face 14 of the valve body 10, to seal the water outlet holes 18 of the valve body 10, so that the fluid is interrupted and cannot flow into the water outlet holes 18 of the valve body 10, thereby preventing the water pipe 40 from being broken due to an excessive pressure. However, the user has to screw the internal thread 422 of the fitting 42 onto the second pipe 52 of the three-way connector 50, and then has to screw the internal thread 411 of the coupling 41 onto the external thread 421 of the fitting 42, thereby causing inconvenience to the user. In addition, the user has to purchase the fitting 42 additionally, thereby increasing the cost of the flow control valve.

### BRIEF SUMMARY OF THE INVENTION

The primary objective of the present invention is to provide a throttling explosion-proof pipe assembly with throttling and explosion-proof functions.

In accordance with the present invention, there is provided a throttling explosion-proof pipe assembly comprising a main body, a control member, a cover and an explosion-proof pipe. The main body has an interior provided with a receiving space for receiving the control member and the cover. The receiving space of the main body has a bottom having a periphery provided with a resting face and having a central position provided with a shaft portion. The shaft portion of the main body has a bottom provided with a stepped face, with a positioning groove being defined between the stepped face and the resting face. The positioning groove of the main body is provided with a plurality of water outlet holes. The control member has a central position provided with a hollow bushing mounted on the shaft portion of the main body. The bushing of the control member has an interior having a bottom provided with a projecting abutment resting on a top of the shaft portion. The control member is provided with an elastic portion resting on the stepped face of the main body. The control member is provided with a positioning projection located in the positioning groove of the main body. The control member is provided with a sealing portion corresponding to the resting face of the main body. The sealing portion of the control member is provided with an abutting face. The cover is secured on an upper portion of the main body and covers the control member. The cover has a central position provided with a flange mounted on the bushing of the control member. The cover has a periphery provided with a plurality of water inlet holes connected to the receiving space of the main body. The explosion-proof pipe is provided with a coupling which has an interior provided with a mounting hole which has an inner diameter equal to an outer diameter of the main body. A nut is rotatably mounted on the explosion-proof pipe through 360 degrees. The nut is provided with an internal thread. The main body, the control member and the cover are integrated to construct a throttling valve that is received in the mounting hole of the explosion-proof pipe.

According to the primary advantage of the present invention, when the pressure of the fluid in the pipeline exceeds a determined value, the elastic portion of the control member is expanded outward and smoothly abuts the stepped face of the main body, and the abutting face of the sealing portion presses the resting face of the main body tightly and closely, to seal the water outlet holes of the main body, so that the fluid is interrupted and cannot flow outward from the water outlet holes of the main body to prevent the explosion-proof pipe from being broken due to the excessive pressure, thereby achieving the purpose of throttling the flow and preventing the explosion-proof pipe from being broken.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a conventional flow control valve in accordance with the prior art.

FIG. 2 is a cross-sectional assembly view of the conventional flow control valve and a three-way connector, and a locally enlarged view taken along mark “E”.

FIG. 3 is a partially exploded perspective view of a throttling explosion-proof pipe assembly in accordance with the preferred embodiment of the present invention.

FIG. 4 is a locally enlarged view of the throttling explosion-proof pipe assembly taken along mark “B” as shown in FIG. 3.

FIG. 5 is an exploded perspective view of the throttling explosion-proof pipe assembly as shown in FIG. 4.

FIG. 6 is a cross-sectional view of the throttling explosion-proof pipe assembly in accordance with the preferred embodiment of the present invention.

FIG. 7 is a cross-sectional view of the throttling explosion-proof pipe assembly taken along line D-D as shown in FIG. 6.

FIG. 8 is a cross-sectional assembly view of the throttling explosion-proof pipe assembly and a three-way connector, and a locally enlarged view taken along mark “Y”.

FIG. 9 is a locally enlarged view of the throttling explosion-proof pipe assembly as shown in FIG. 8, wherein the flow pressure of the fluid is under the normal condition.

FIG. 10 is a locally enlarged view of the throttling explosion-proof pipe assembly as shown in FIG. 8, wherein the flow pressure of the fluid is under the abnormal condition.

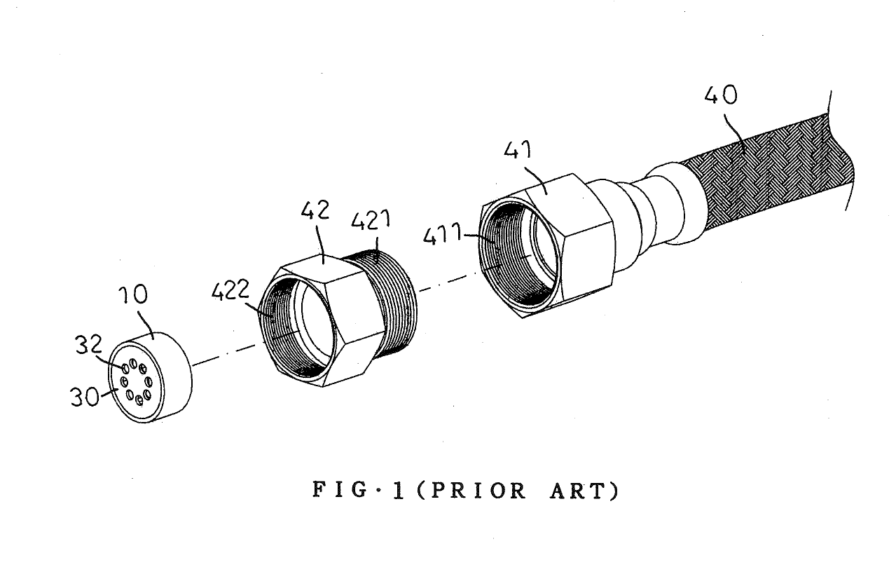

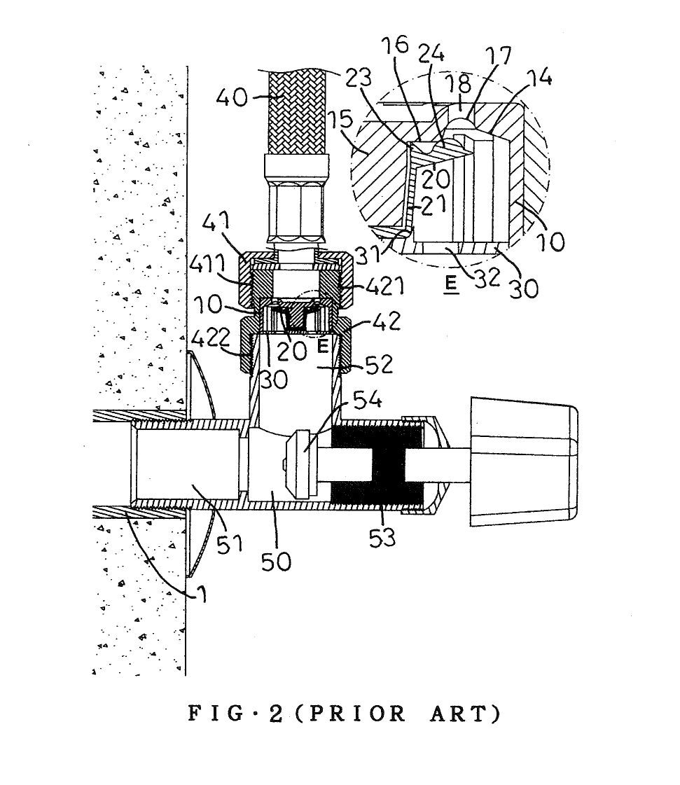

### DETAILED DESCRIPTION OF THE INVENTION

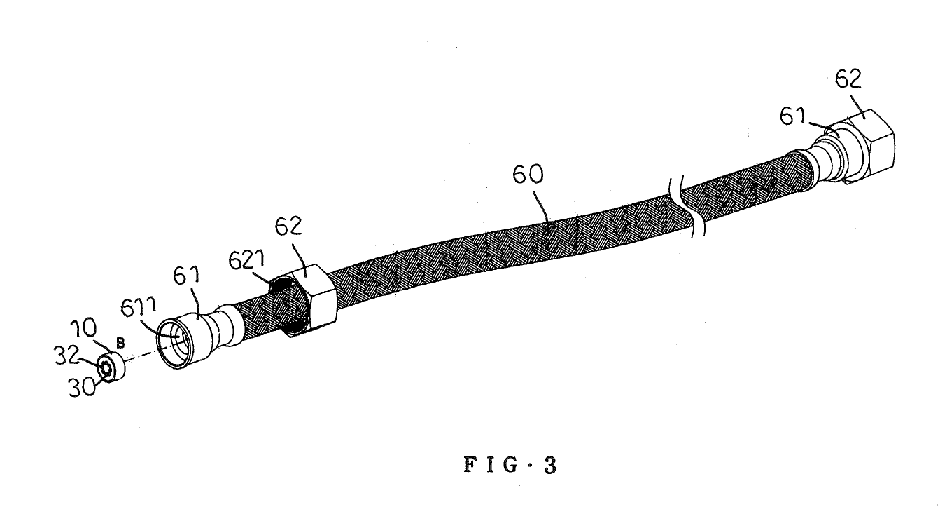

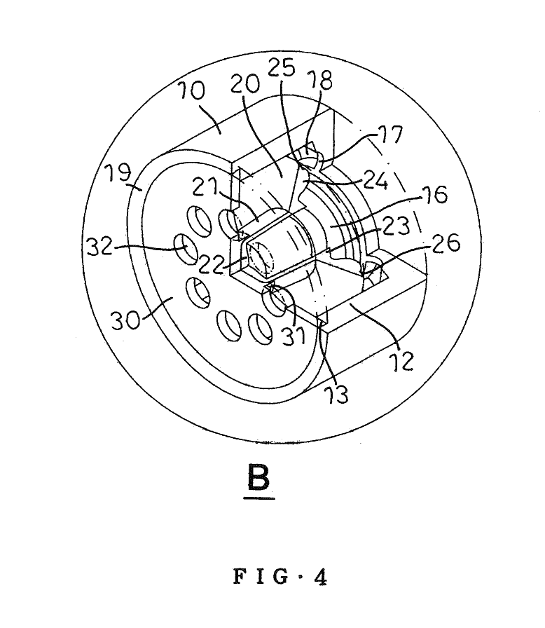

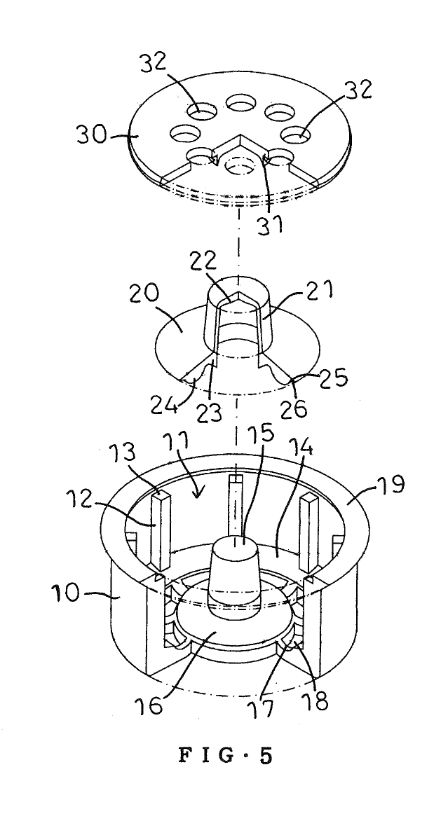

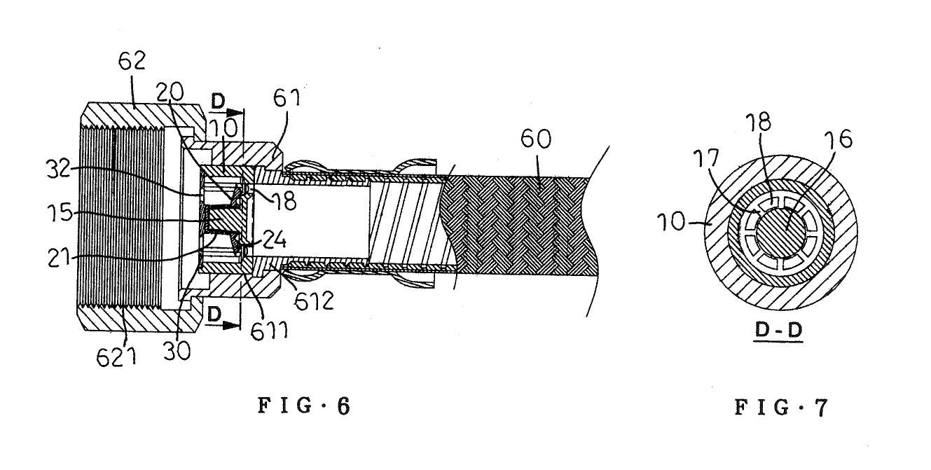

Referring to the drawings and initially to FIGS. 3-7, a throttling explosion-proof pipe assembly in accordance with the preferred embodiment of the present invention comprises a main body 10, a control member 20, a cover 30, and an explosion-proof pipe 60.

The main body 10 has an interior provided with a receiving space 11 for receiving the control member 20 and the cover 30. The receiving space 11 of the main body 10 has a bottom having a periphery provided with a resting face 14 and having a central position provided with a shaft portion 15 for positioning the control member 20. The shaft portion 15 of the main body 10 has a bottom provided with a stepped face 16, with a positioning groove 17 being defined between the stepped face 16 and the resting face 14. The positioning groove 17 of the main body 10 is provided with a plurality of water outlet holes 18 that are arranged in a radiating manner and are equally distant from each other so that a fluid is evenly diffused from the resting face 14 of the main body 10 and flows outward from the water outlet holes 18 of the main body 10.

The control member 20 has a central position provided with a hollow bushing 21 mounted on the shaft portion 15 of the main body 10. The bushing 21 of the control member 20 has an interior having a bottom provided with a projecting abutment 22 resting on a top of the shaft portion 15. When the control member 20 is subjected to a determined pressure, a top of the bushing 21 extends downward to present an arcuate shape. The control member 20 is provided with an elastic portion 23 resting on the stepped face 16 of the main body 10. When the elastic portion 23 of the control member 20 is subjected to a force, the elastic portion 23 of the control member 20 is contracted inward or expanded outward to present an elastic deformation. The control member 20 is provided with a positioning projection 24 located in the positioning groove 17 of the main body 10. The positioning projection 24 of the control member 20 has a shape and a size conforming to that of the positioning groove 17 of the main body 10. The control member 20 is provided with a sealing portion 25 corresponding to the resting face 14 of the main body 10. The sealing portion 25 of the control member 20 is provided with an abutting face 26. When a flow pressure of the fluid is under a normal condition, the elastic portion 23 of the control member 20 is contracted inward, and the abutting face 26 of the control member 20 is disposed at an open state. When the flow pressure of the fluid is under an abnormal condition and has an excessive value, the elastic portion 23 of the control member 20 is expanded outward and abuts the stepped face 16 of the main body 10, and the abutting face 26 of the control member 20 presses the resting face 14 of the main body 10 tightly and closely, to seal the water outlet holes 18 of the main body 10, to prevent the fluid from flowing outward from the water outlet holes 18 of the main body 10, and to prevent the explosion-proof pipe 60 from being broken.

The cover 30 is secured on an upper portion of the main body 10 and covers the control member 20. The cover 30 has a central position provided with a flange 31 mounted on the bushing 21 of the control member 20. The cover 30 has a periphery provided with a plurality of water inlet holes 32 connected to the receiving space 11 of the main body 10. The water inlet holes 32 of the cover 30 are equally distant from each other so that the fluid evenly flows from the water inlet holes 32 of the cover 30 into the receiving space 11 of the main body 10.

The explosion-proof pipe 60 is provided with a coupling 61 which has an interior provided with a mounting hole 611 which has an inner diameter equal to an outer diameter of the main body 10. A nut 62 is rotatably mounted on the explosion-proof pipe 60 through 360 degrees. The nut 62 is provided with an internal thread 621. The main body 10, the control member 20 and the cover 30 are integrated to construct a throttling valve that is received in the mounting hole 611 of the explosion-proof pipe 60.

In the preferred embodiment of the present invention, each of the main body 10 and the cover 30 is made of fiber reinforced plastics (FRP).

In the preferred embodiment of the present invention, the control member 20 is made of an elastically deformable material, such as silicone or rubber.

In the preferred embodiment of the present invention, each of the positioning groove 17 of the main body 10 has a substantially semi-circular shape, and the positioning projection 24 of the control member 20 has a substantially semi-circular shape.

In the preferred embodiment of the present invention, the shaft portion 15 of the main body 10 has a substantially conical shape with a narrower upper end and a wider lower end, and the bushing 21 of the control member 20 has a substantially conical shape with a narrower upper end and a wider lower end.

In the preferred embodiment of the present invention, the receiving space 11 of the main body 10 has an inner wall provided with a plurality of upright ribs 12 that are arranged in a longitudinal direction. Each of the ribs 12 has an upper end defining a space forming a stepped edge 13 on which the cover 30 rests.

In the preferred embodiment of the present invention, the resting face 14 of the main body 10 has an inclined shape with a higher outer portion and a lower inner portion.

In the preferred embodiment of the present invention, the upper portion of the main body 10 is provided with an enlarged stop edge 19 for positioning the main body 10 in a pipeline or a coupling.

In the preferred embodiment of the present invention, the explosion-proof pipe 60 has an inner layer provided with a rubber tube which has an outer layer provided with at least one weaving layer that is woven by a steel wire.

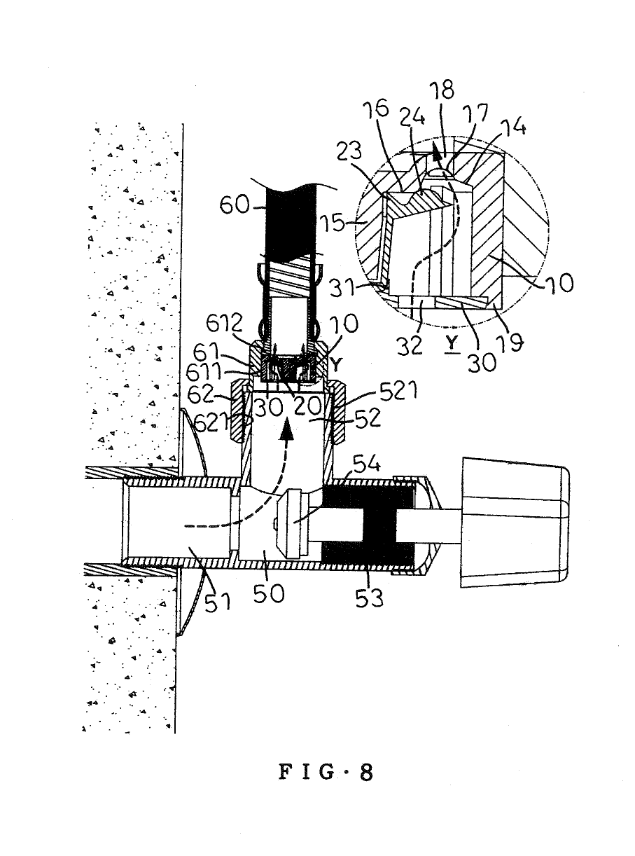

In assembly, referring to FIG. 8 with reference to FIGS. 3-7, the explosion-proof pipe 60 is attached to a faucet (not shown) of a sink (not shown). A water inlet pipe is mounted in a wall. A three-way connector 50 is mounted between the water inlet pipe and the explosion-proof pipe 60. The three-way connector 50 includes a first pipe 51 fitted into the water inlet pipe, a second pipe 52 connected with the coupling 61 of the explosion-proof pipe 60 and a third pipe 53 provided with a switch 54. The internal thread 621 of the nut 62 is screwed onto an external thread of the second pipe 52 to secure the coupling 61 of the explosion-proof pipe 60 to the second pipe 52 of the three-way connector 50. At this time, the throttling valve (including the main body 10, the control member 20 and the cover 30) is received in the mounting hole 611 of the coupling 61 of the explosion-proof pipe 60. The switch 54 is movable between a first position where the first pipe 51 is connected to the second pipe 52 so that the water in the water inlet pipe flows through the first pipe 51, the second pipe 52 and the explosion-proof pipe 60 into the faucet, and a second position where the first pipe 51 is disconnected from the second pipe 52 so that the water in the water inlet pipe is interrupted and cannot flow into the faucet.

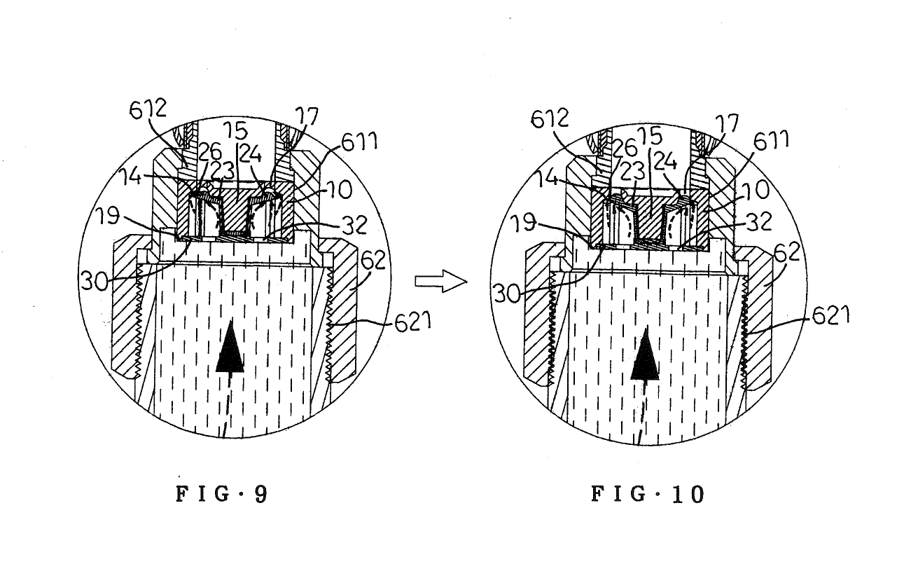

In operation, referring to FIGS. 8 and 9 with reference to FIGS. 3-7, when the flow pressure (or rate) of the fluid is under the normal condition, the fluid from the water inlet pipe flows through the first pipe 51 into the second pipe 52, then evenly flows from the water inlet holes 32 of the cover 30 into the receiving space 11 of the main body 10, and then flows through the water outlet holes 18 of the main body 10 into the explosion-proof pipe 60.

Referring to FIG. 10 with reference to FIGS. 3-7, when the flow pressure (or rate) of the fluid is under the abnormal condition, the elastic portion 23 of the control member 20 is expanded outward and presses the stepped face 16 of the main body 10, so that the abutting face 26 of the sealing portion 25 of the control member 20 presses the resting face 14 of the main body 10 tightly and closely, to seal the water outlet holes 18 of the main body 10, so that the fluid is interrupted and cannot flow through the water outlet holes 18 of the main body 10 into the explosion-proof pipe 60, thereby preventing the explosion-proof pipe 60 from being broken due to an excessive pressure.

Accordingly, when the pressure of the fluid in the pipeline exceeds a determined value, the elastic portion 23 of the control member 20 is expanded outward and smoothly abuts the stepped face 16 of the main body 10, and the abutting face 26 of the sealing portion 25 presses the resting face 14 of the main body 10 tightly and closely, to seal the water outlet holes 18 of the main body 10, so that the fluid is interrupted and cannot flow outward from the water outlet holes 18 of the main body 10, to prevent the explosion-proof pipe 60 from being broken due to the excessive pressure, thereby achieving the purpose of throttling the flow and preventing the explosion-proof pipe 60 from being broken. In addition, the nut 62 is rotatably mounted on the explosion-proof pipe 60 and is directly screwed onto the second pipe 52 of the three-way connector 50, to secure the coupling 61 of the explosion-proof pipe 60 to the second pipe 52 of the three-way connector 50, thereby facilitating the user assembling the explosion-proof pipe 60 with the three-way connector 50.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A throttling explosion-proof pipe assembly comprising:
a main body, a control member, a cover and an explosion-proof pipe;
wherein:
the main body has an interior provided with a receiving space for receiving the control member and the cover;
the receiving space of the main body has a bottom having a periphery provided with a resting face and having a central position provided with a shaft portion;
the shaft portion of the main body has a bottom provided with a stepped face, with a positioning groove being defined between the stepped face and the resting face;
the positioning groove of the main body is provided with a plurality of water outlet holes;
the control member has a central position provided with a hollow bushing mounted on the shaft portion of the main body;
the bushing of the control member has an interior having a bottom provided with a projecting abutment resting on a top of the shaft portion;
the control member is provided with an elastic portion resting on the stepped face of the main body;
the control member is provided with a positioning projection located in the positioning groove of the main body;
the control member is provided with a sealing portion corresponding to the resting face of the main body;
the sealing portion of the control member is provided with an abutting face;
the cover is secured on an upper portion of the main body and covers the control member;
the cover has a central position provided with a flange mounted on the bushing of the control member;
the cover has a periphery provided with a plurality of water inlet holes connected to the receiving space of the main body;
the explosion-proof pipe is provided with a coupling which has an interior provided with a mounting hole which has an inner diameter equal to an outer diameter of the main body;
a nut is rotatably mounted on the explosion-proof pipe through 360 degrees;
the nut is provided with an internal thread; and
the main body, the control member and the cover are integrated to construct a throttling valve that is received in the mounting hole of the explosion-proof pipe.

2. The throttling explosion-proof pipe assembly of claim 1, wherein the main body and the cover are made of fiber reinforced plastics (FRP).

3. The throttling explosion-proof pipe assembly of claim 1, wherein the control member is made of silicone or rubber.

4. The throttling explosion-proof pipe assembly of claim 1, wherein each of the positioning groove of the main body has a substantially semi-circular shape, and the positioning projection of the control member has a substantially semi-circular shape.

5. The throttling explosion-proof pipe assembly of claim 1, wherein the shaft portion of the main body has a substantially conical shape with a narrower upper end and a wider lower end, and the bushing of the control member has a substantially conical shape with a narrower upper end and a wider lower end.

6. The throttling explosion-proof pipe assembly of claim 1, wherein the receiving space of the main body has an inner wall provided with a plurality of upright ribs, and each of the ribs has an upper end defining a space forming a stepped edge on which the cover rests.

7. The throttling explosion-proof pipe assembly of claim 1, wherein the resting face of the main body has an inclined shape with a higher outer portion and a lower inner portion.

8. The throttling explosion-proof pipe assembly of claim 1, wherein the upper portion of the main body is provided with an enlarged stop edge.

9. The throttling explosion-proof pipe assembly of claim 1, wherein the explosion-proof pipe has an inner layer provided with a rubber tube which has an outer layer provided with at least one weaving layer that is woven by a steel wire.
